(19) United States
(12) Patent Application Publication
(10) Pub. No.: US 2026/0351452 A1
(43) Pub. Date: Nov. 5, 2026

(54) MAGNETIC PARTICLE-CONTAINING SHEET, INDUCTOR, AND ELECTRONIC CIRCUIT

(71) Applicant: FUJIFILM Corporation, Tokyo (JP)

(72) Inventor: Tatsuo MIKAMI, Minamiashigara-shi (JP)

(73) Assignee: FUJIFILM Corporation, Tokyo (JP)

(21) Appl. No.: 19/701,794

(22) Filed: Jun. 9, 2026

Related U.S. Application Data
(63) Continuation of application No. PCT/JP2024/043008, filed on Dec. 5, 2024.

(30) Foreign Application Priority Data
Dec. 15, 2023 (JP) 2023-212155

(51) Int. Cl. H01F 1/20

(52) U.S. Cl. CPC H01F 1/20

(57) ABSTRACT

The magnetic particle-containing sheet satisfies (1), (2), and (3). (1) an arithmetic mean of median values of major-axis diameters of magnetic particles obtained from respective five images acquired by SEM observation of any five measurement regions on a surface of the magnetic particle-containing sheet is 1.20 μm or less; (2) an arithmetic mean of the numbers of magnetic particles having major-axis diameters of 5.00 μm or more, the major-axis diameters being obtained from the respective five images, is 6 or more; and (3) a maximum value of arithmetic means of magnetic particle spacings, the arithmetic means being obtained from respective 12 images acquired by SEM observation of any one measurement region on the surface of the magnetic particle-containing sheet at respective measurement angles of 0°, 15°, 30°, 45°, 60°, 75°, 90°, 105°, 120°, 135°, 150°, and 165°, is 1.20 μm or less.

### CROSS-REFERENCE TO RELATED APPLICATIONS

This application is a Continuation of PCT International Application No. PCT/JP2024/043008 filed on Dec. 5, 2024, which claims priority under 35 U.S.C. § 119 (a) to Japanese Patent Application No. 2023-212155 filed on Dec. 15, 2023. Each of the above applications is hereby expressly incorporated by reference, in its entirety, into the present application.

### BACKGROUND OF THE INVENTION

### 1. Field of the Invention

The present invention relates to a magnetic particle-containing sheet, an inductor, and an electronic circuit.

### 2. Description of the Related Art

An inductor is a passive electronic element included in various electronic circuits. As the inductor, an inductor including a magnetic particle-containing sheet and a coil is known (for example, see paragraph 0035 of JP2014-127624A).

### SUMMARY OF THE INVENTION

An inductance, which is a principal performance of an inductor, is proportional to a magnetic permeability of the magnetic particle-containing sheet. Therefore, in order to realize an inductor having a high inductance or a small inductor, a magnetic particle-containing sheet having a high magnetic permeability is desirable. However, the magnetic permeability of the magnetic particle-containing sheet may vary depending on the angle in the sheet surface. Therefore, in a case where a plurality of magnetic particle-containing sheets are cut out from different angular positions of the same magnetic particle-containing sheet stock, a variation in the inductance may occur among inductors incorporating respective ones of the plurality of magnetic particle-containing sheets. Therefore, from the viewpoint of the stability of the performance of the inductor, a magnetic particle-containing sheet that exhibits a high magnetic permeability at various angles is desirable.

In view of the above, an object of one aspect of the present invention is to provide a magnetic particle-containing sheet that can exhibit a high magnetic permeability at various angles.

One aspect of the present invention is as follows.
[1] A magnetic particle-containing sheet satisfying the following (1), (2), and (3):
(1) an arithmetic mean of median values of major-axis diameters of magnetic particles obtained from respective five images acquired by observing any five measurement regions on a surface of the magnetic particle-containing sheet with a scanning electron microscope is 1.20 μm or less, each of the five measurement regions has a size of 63 μm×47 μm, and an observation magnification of the scanning electron microscope is 3000×;
(2) an arithmetic mean of the numbers of magnetic particles having major-axis diameters of 5.00 μm or more, the major-axis diameters being obtained from the respective five images, is 6 or more; and
(3) with an arbitrary measurement angle being defined as 0°, a maximum value of arithmetic means of magnetic particle spacings, the arithmetic means being obtained from respective 12 images acquired by observing any one measurement region on the surface of the magnetic particle-containing sheet with the scanning electron microscope at respective measurement angles of 0°, 15°, 30°, 45°, 60°, 75°, 90°, 105°, 120°, 135°, 150°, and 165°, is 1.20 μm or less, the one measurement region has a size of 63 μm×47 μm, and an observation magnification of the scanning electron microscope is 3000×.
[2] The magnetic particle-containing sheet according to [1], in which the maximum value of the arithmetic means of the magnetic particle spacings in (3) is 1.00 μm or less.
[3] The magnetic particle-containing sheet according to [1] or [2], in which, with the maximum value of the arithmetic means of the magnetic particle spacings in (3) being defined as GAPH and a minimum value of the arithmetic means of the magnetic particle spacings in (3) being defined as GAPL, ΔGAP obtained by the following expression:

ΔGAP=(GAPH−GAPL)/(GAPH+GAPL)
is 0.13 or less.
[4] The magnetic particle-containing sheet according to [3], in which the ΔGAP is 0.05 or more and 0.13 or less.
[5] The magnetic particle-containing sheet according to any one of [1] to [4], in which the arithmetic mean of the median values of the major-axis diameters in (1) is 0.80 μm or more and 1.20 μm or less.
[6] The magnetic particle-containing sheet according to any one of [1] to [5], in which the arithmetic mean of the numbers in (2) is 6 or more and 20 or less.
[7] The magnetic particle-containing sheet according to any one of [1] to [6], in which the maximum value of the arithmetic means of the magnetic particle spacings in (3) is 0.80 μm or more and 1.20 μm or less.
[8] The magnetic particle-containing sheet according to any one of [1] to [7], in which the magnetic particle-containing sheet further contains a resin.
[9] The magnetic particle-containing sheet according to any one of [1] to [8], in which the maximum value of the arithmetic means of the magnetic particle spacings in (3) is 1.00 μm or less, and
with the maximum value of the arithmetic means of the magnetic particle spacings in (3) being defined as GAPH and a minimum value of the arithmetic means of the magnetic particle spacings in (3) being defined as GAPL, ΔGAP obtained by the following expression:

ΔGAP=(GAPH−GAPL)/(GAPH+GAPL)
is 0.13 or less.
[10] The magnetic particle-containing sheet according to [9], in which the ΔGAP is 0.05 or more and 0.13 or less,
the arithmetic mean of the median values of the major-axis diameters in (1) is 0.80 μm or more and 1.20 μm or less,
the arithmetic mean of the numbers in (2) is 6 or more and 20 or less,
the maximum value of the arithmetic means of the magnetic particle spacings in (3) is 0.80 μm or more and 1.00 μm or less, and
the magnetic particle-containing sheet further contains a resin.
[11] An inductor comprising the magnetic particle-containing sheet according to any one of [1] to [10].
[12] An electronic circuit including the inductor according to [11].

According to one aspect of the present invention, it is possible to provide a magnetic particle-containing sheet capable of exhibiting a high magnetic permeability at various angles. In addition, according to one aspect of the present invention, it is possible to provide an inductor including a magnetic particle-containing sheet capable of exhibiting a high magnetic permeability at various angles, and an electronic circuit including such an inductor.

### DESCRIPTION OF THE PREFERRED EMBODIMENTS

### [Magnetic Particle-Containing Sheet]

One aspect of the present invention relates to a magnetic particle-containing sheet satisfying (1), (2), and (3) described above.

In the present invention and the present specification, “magnetic property” means having a ferromagnetic property. In addition, in the present invention and the present specification, the term “sheet” is used in the same meaning as the term “film”.

(1), (2), and (3) described above are obtained by the following measuring methods. In the present invention and the present specification, the term “any measurement region” means a measurement region selected at random, the term “any measurement angle” means a measurement angle selected at random, and the term “any position” means a position selected at random.

A magnetic particle-containing sheet to be measured is used as a measurement sample, or a sheet piece cut out from any position of the magnetic particle-containing sheet to be measured is used as a measurement sample. The size of the measurement sample may be a size that can be introduced into a scanning electron microscope (SEM) and that allows SEM observation of the following plurality of measurement regions. In the SEM observation, the size of one measurement region is set to 63 μm×47 μm, and the observation magnification is set to 3000×. The image acquired by the SEM is a backscattered electron image.

Regarding the surface to be measured, the surface having a larger arithmetic average roughness Ra out of both surfaces of the measurement sample is defined as the surface to be measured. In the magnetic particle-containing sheet produced by applying a composition for forming a magnetic particle-containing sheet onto a support, as will be described later, the surface on the side opposite to the support during the coating has a clearly larger Ra than the surface on the support side during the coating. Therefore, for such a surface, the surface may be defined as the surface to be measured without measuring Ra.

In a case where Ra is measured to determine the surface to be measured, an optical interferometer is used for the measurement of Ra. In this case, the surface to be measured is determined based on the value of Ra obtained by measuring a region of 140 μm×105 μm on each surface. Examples of the measurement conditions of the optical interferometer include the following measurement conditions.

Using an optical interferometer (newview 7300 manufactured by Zygo Corporation), a region of an area of 140 μm×105 μm on the surface to be measured for Ra is measured. The resolution is set to 640 pixels×480 pixels. For the obtained three-dimensional roughness profile, a measurement auxiliary line is drawn from end to end of the measurement region in the longitudinal direction of the measurement region, that is, in the lateral direction of the screen, and Ra is calculated. This measurement is performed five times by changing the position in the short direction of the measurement region, that is, the vertical direction of the screen. The arithmetic mean of the five measured values thus obtained is defined as Ra of the surface to be measured for Ra.

As the SEM, an SEM having a scan rotation function capable of acquiring images at different measurement angles for the same observation region is used. The scan rotation function is a function of rotating the image on the screen by changing the scanning direction of the electron probe. As such an SEM, for example, a tabletop microscope TM-1000 manufactured by Hitachi High-Tech Corporation can be used. In the measurement described in the column of Examples described later, a tabletop microscope TM-1000 manufactured by Hitachi High-Tech Corporation was used as the SEM.

Regarding the above (1) and (2), five different locations selected at random on the surface to be measured are defined as measurement regions, SEM observation is performed on each of the five measurement regions, and a total of five images are acquired.

Regarding the above (3), one region different from the five measurement regions is selected at random and defined as a measurement region. For this measurement region, any measurement angle is set to 0°, and SEM observation is performed at respective measurement angles of 0°, 15°, 30°, 45°, 60°, 75°, 90°, 105°, 120°, 135°, 150°, and 165° to acquire an image. The measurement angle can be set by the SEM. For example, in the tabletop microscope TM-1000 manufactured by Hitachi High-Tech Corporation, by setting 0 of the rotation button to 0° and clicking+of the rotation button while changing the angle, SEM observation can be performed at measurement angles of 0°, 15°, 30°, 45°, 60°, 75°, 90°, 105°, 120°, 135°, 150°, and 165°, and a total of 12 images can be acquired.

Each of the above images is subjected to binarization processing by the following method.

The acquired image is read out in gray scale with a second argument of 0 by a cv2.imread( ) function of an image processing library OpenCV 4 (manufactured by Intel Corporation). The scale bar portion is cut out from an image having an image size of 1,280 pixels×1,040 pixels, and the size is adjusted to an image size of 1,280 pixels×957 pixels. The adjusted image is binarized by a cv2.threshold( ) function with a fourth argument of cv2.THRESH_OTSU to obtain a binarized image. In such a binarized image, a white portion is regarded as magnetic particles, and a black portion is regarded as a region between the magnetic particles.

Regarding the above (1), in the binarized image, a major-axis diameter of all the magnetic particles (white portions) included in each image is obtained. However, for particles in which only a part of the particle shape is included in the binarized image and the entire particles are not included, the major-axis diameter is not obtained. The “major-axis diameter” is obtained as a diameter of a circumscribed circle of a contour of the white portion, which is drawn using image processing software. Such a circumscribed circle can be drawn by known image processing software. After obtaining the major-axis diameters of all the magnetic particles for each image in this way, a median value of the values of the major-axis diameters is obtained. In a case where the total number of measured values is odd, the median value is a measured value in the middle in a case where the measured values are arranged in ascending order. In a case where the total number of measured values is even, the median value is an arithmetic mean of two values closest to the middle in a case where the measured values are arranged in ascending order. An arithmetic mean of five median values of the major-axis diameters of the magnetic particles obtained for the five images in this way is defined as the arithmetic mean of the median values of the major-axis diameters in the above (1).

Regarding the above (2), for each of the five images, the number of magnetic particles having a major-axis diameter of 5.00 μm or more among all the magnetic particles of which the major-axis diameter is obtained as described above is obtained. An arithmetic mean of five values of the number obtained for the five images in this way is defined as the arithmetic mean of the number in the above (2).

Regarding the above (3), at each Y coordinate of Y=100, 200, 300, 400, 500, 600, 700, 800, and 900 of the binarized image obtained as described above, the brightness of the pixel at the coordinates of X=0 to 1279 is read out, the number of consecutive brightnesses of 0 is measured, and the result is multiplied by 67 μm/1280 pixels to obtain the particle spacing [μm]. That is, in a case where the number of consecutive brightnesses of 0 is N, the particle spacing [μm] is calculated as “N×67/1280”. For each of the 12 images acquired by changing the measurement angle, an arithmetic mean of the values of the particle spacing obtained in the image is defined as the arithmetic mean of the magnetic particle spacings of the magnetic particles in the image. A maximum value among 12 values of the arithmetic mean of the magnetic particle spacings of the magnetic particles obtained for the 12 images is defined as the maximum value of the arithmetic means of the magnetic particle spacings of the magnetic particles in the above (3).

Specific examples of the measurement methods of above (1) to (3) include the measurement methods described in the section of Examples later.

The present inventors consider that the magnetic particles that mainly contribute to the high magnetic permeability of the magnetic particle-containing sheet are magnetic particles having a large particle size among the magnetic particles contained in the magnetic particle-containing sheet. The present inventors consider that the magnetic particle-containing sheet in which the arithmetic mean of the number in the above (2) is 6 or more contains a large number of such large magnetic particles. Further, in order to suppress a decrease in the high magnetic permeability brought about by the magnetic particles having a large particle size, it is considered desirable that the amount of the non-magnetic portion present between the magnetic particles having a large particle size is small. In this regard, the present inventors speculate that, in the magnetic particle-containing sheet in which the arithmetic mean of the median values of the major-axis diameters in the above (1) is 1.20 μm or less, there are many magnetic particles having a small particle size present between the magnetic particles having a large particle size, in other words, the amount of the non-magnetic portion present between the magnetic particles having a large particle size is small, and thus it is possible to suppress a decrease in the high magnetic permeability brought about by the magnetic particles having a large particle size. In addition, it is considered that a narrow spacing between the magnetic particles also contributes to an increase in the magnetic permeability of the magnetic particle-containing sheet. In this regard, the fact that the maximum value of the arithmetic means of the magnetic particle spacings of the magnetic particles in the above (3) is 1.20 μm or less means that the arithmetic mean of the magnetic particle spacings of the magnetic particles is 1.20 μm or less in any of the 12 images. Therefore, the present inventors consider that the magnetic particle-containing sheet in which the maximum value of the arithmetic means of the magnetic particle spacings of the magnetic particles in the above (3) is 1.20 μm or less can be said to be a magnetic particle-containing sheet in which the spacing between the magnetic particles is narrow in a case of being observed at various angles.

The present inventors speculate that the above-described point is the reason why the magnetic particle-containing sheet in which the arithmetic mean of the median values of the major-axis diameters in the above (1) is 1.20 μm or less, the arithmetic mean of the number in the above (2) is 6 or more, and the maximum value of the arithmetic means of the magnetic particle spacings of the magnetic particles in the above (3) is 1.20 μm or less can exhibit a high magnetic permeability at various angles. However, the present invention is not limited to the presumption described in the present specification. In addition, the fact that a high magnetic permeability is exhibited at various angles can be confirmed, for example, by the fact that the magnetic permeability measured at various angles is high on average (for example, the value of the arithmetic mean is large).

Hereinafter, the magnetic particle-containing sheet will be described in more detail.

### <Arithmetic Mean of Median Values of Major-Axis Diameters in (1)>

The arithmetic mean of the median values of the major-axis diameters in the above (1) is an arithmetic mean (arithmetic mean of five values) of the median values of the major-axis diameters of the magnetic particles obtained from respective five images acquired by observing any five measurement regions on the surface of the magnetic particle-containing sheet with a SEM. The arithmetic mean of the median values of the major-axis diameters in the above (1) of the magnetic particle-containing sheet is 1.20 μm or less. This can contribute to the fact that the magnetic particle-containing sheet can exhibit a high magnetic permeability at various angles. From such a viewpoint, the arithmetic mean of the median values of the major-axis diameters in the above (1) of the magnetic particle-containing sheet is preferably 1.18 μm or less, and more preferably 1.16 μm or less, 1.14 μm or less, 1.12 μm or less, 1.10 μm or less, and 1.00 μm or less in this order. The arithmetic mean of the median values of the major-axis diameters in the above (1) of the magnetic particle-containing sheet can be, for example, 0.50 μm or more, 0.60 μm or more, 0.70 μm or more, 0.80 μm or more, or 0.90 μm or more. However, from the viewpoint of high magnetic permeability enhancement of the magnetic particle-containing sheet, it is preferable that the arithmetic mean of the median values of the major-axis diameters in the above (1) is small. Therefore, the arithmetic mean of the median values of the major-axis diameters in the above (1) of the magnetic particle-containing sheet may be lower than the values exemplified here.

### <Arithmetic Mean of Numbers of (2)>

The arithmetic mean of the numbers of (2) is an arithmetic mean (arithmetic mean of five values) of the numbers of magnetic particles having major-axis diameters of 5.00 μm or more, the major-axis diameters being obtained from the respective five images. The arithmetic mean of the numbers of (2) of the magnetic particle-containing sheet is 6 or more. This can also contribute to the fact that the magnetic particle-containing sheet can exhibit a high magnetic permeability at various angles. From such a viewpoint, the arithmetic mean of the numbers in (2) of the magnetic particle-containing sheet is preferably 7 or more, and more preferably 8 or more, 9 or more, and 10 or more in this order. The arithmetic mean of the numbers in (2) of the magnetic particle-containing sheet can be, for example, 20 or less, 19 or less, 18 or less, 17 or less, 16 or less, 15 or less, or 14 or less. However, from the viewpoint of high magnetic permeability enhancement of the magnetic particle-containing sheet, it is preferable that the arithmetic mean of the numbers in (2) is large. Therefore, the arithmetic mean of the numbers in (2) of the magnetic particle-containing sheet may exceed the values exemplified here.

### <Maximum Value of Arithmetic Means of Magnetic Particle Spacings of (3)>

The maximum value of the arithmetic means of the magnetic particle spacings of (3) is a maximum value of arithmetic means of magnetic particle spacings (the maximum value among 12 values) obtained from respective 12 images acquired by observing any one measurement region on the surface of the magnetic particle-containing sheet at respective measurement angles of 0°, 15°, 30°, 45°, 60°, 75°, 90°, 105°, 120°, 135°, 150°, and 165° with a scanning electron microscope, with any measurement angle being defined as 0°. The maximum value of the arithmetic means of the magnetic particle spacings of (3) of the magnetic particle-containing sheet is 1.20 μm or less. This can also contribute to the fact that the magnetic particle-containing sheet can exhibit a high magnetic permeability at various angles. From such a viewpoint, the maximum value of the arithmetic means of the magnetic particle spacings of (3) is preferably 1.18 μm or less, and more preferably 1.16 μm or less, 1.14 μm or less, 1.12 μm or less, 1.10 μm or less, and 1.00 μm or less in this order. The maximum value of the arithmetic means of the magnetic particle spacings of (3) of the magnetic particle-containing sheet can be, for example, 0.50 μm or more, 0.60 μm or more, 0.70 μm or more, 0.80 μm or more, or 0.90 μm or more. However, from the viewpoint of high magnetic permeability enhancement of the magnetic particle-containing sheet, it is preferable that the maximum value of the arithmetic means of the magnetic particle spacings of (3) is small. Therefore, the maximum value of the arithmetic means of the magnetic particle spacings of (3) of the magnetic particle-containing sheet may be lower than the values exemplified here.

### <ΔGAP>

Regarding the inductor, for example, in a case where a plurality of magnetic particle-containing sheets are cut out from different angular positions of the same magnetic particle-containing sheet stock, a large variation in inductance may occur among inductors incorporating respective ones of the plurality of magnetic particle-containing sheets. From the viewpoint of suppressing the occurrence of this phenomenon or suppressing the degree of the phenomenon, it is desirable that the magnetic permeability of the magnetic particle-containing sheet has a small angle dependence, that is, the anisotropy of the magnetic permeability is small. As a result of the studies by the present inventors on this point, it was found that, with the maximum value among the arithmetic means of the magnetic particle spacings determined in the respective 12 images for (3) being defined as GAPH and the minimum value being defined as GAPL, a magnetic particle-containing sheet having a small ΔGAP determined by the following formula:

ΔGAP=(GAPH−GAPL)/(GAPH+GAPL)
has small anisotropy in magnetic permeability. Here, “GAP” is an abbreviation for “gap between magnetic particles”, “H” in “GAPH” is an abbreviation for “Highest”, and “L” in “GAPL” is an abbreviation for “Lowest”. A small value of ΔGAP means that the variation in the arithmetic mean of the magnetic particle spacings at various measurement angles is small. The ΔGAP of the magnetic particle-containing sheet can be, for example, 0.24 or less, 0.23 or less, or 0.22 or less, and from the viewpoint of reducing the anisotropy of the magnetic permeability of the magnetic particle-containing sheet, it is preferably 0.13 or less, and more preferably 0.12 or less, 0.11 or less, and 0.10 or less in this order. The ΔGAP of the magnetic particle-containing sheet can be, for example, 0.01 or more, 0.05 or more, or 0.10 or more. However, from the viewpoint of reducing the anisotropy of the magnetic permeability of the magnetic particle-containing sheet, it is preferable that ΔGAP is small. Therefore, the ΔGAP of the magnetic particle-containing sheet may be lower than the values exemplified here.

Examples of a method of controlling the various values of (1) to (3) include a method of using a plurality of kinds of magnetic particles having different particle sizes as the magnetic particles used for producing the magnetic particle-containing sheet, and controlling the particle sizes and the mixing ratio of the magnetic particles. In addition, examples of a method of controlling the arithmetic mean of the magnetic particle spacings in (3) include a method of adjusting the amount of the resin described later. Examples of a method of controlling ΔGAP include a method of adjusting the liquid viscosity of the composition used for producing the magnetic particle-containing sheet.

Hereinafter, the magnetic particle-containing sheet will be described in more detail.

### <Magnetic Particles>

As the magnetic particles contained in the magnetic particle-containing sheet, one kind selected from the group consisting of magnetic particles generally called soft magnetic particles, such as metal particles and ferrite particles, can be used, or two or more kinds thereof can be used in combination. In the present invention and the present specification, the term “particle” is used to mean a single particle or an aggregate of particles. In the aggregate of the magnetic particles, the magnetic particles may be in direct contact with each other on at least a part of the particle surface, or another component (for example, a resin described later, other components described later, and the like) may be interposed between the magnetic particles.

In the present invention and the present specification, the “metal particle” includes pure metal particles consisting of a single metal element, alloy particles of one or more metal elements and one or two or more other metal elements and/or non-metal elements. The metal particles may be or may not be crystalline. That is, the metal particles may be crystalline particles or amorphous particles. For example, as the metal particles, magnetic particles commercially available as a nanocrystalline alloy, magnetic particles commercially available as an iron-based amorphous alloy, and the like can be used. The “iron-based (Fe-based)” means that iron is included as a constituent element. Examples of the metal or non-metal element included in the metal particles include Ni, Fe, Co, Mo, Cr, Si, B, and P. The metal particles may or may not include a component other than the constituent elements of the metal (including the alloy). The metal particles may contain, in addition to the constituent element of the metal (including the alloy), elements contained in an additive that can be optionally added and/or elements contained in impurities that can be unintentionally mixed in a manufacturing process of the metal particles at any content rate. In the metal particles, the content of the constituent element of the metal (including the alloy) is preferably 90.0% by mass or more and more preferably 95.0% by mass or more, and it may be 100% by mass or may be less than 100% by mass, 99.9% by mass or less, or 99.0% by mass or less.

Examples of an indicator of the particle size of the magnetic particles include “d50” which is a cumulative 50% diameter in a number-based particle size distribution measured by a laser diffraction/scattering method. The d50 can be measured, for example, by the following method. The d50 described in the column of Examples described later is a value measured by the following method.

500 mL of cyclohexanone is added to 10 mg of the magnetic particles for dilution, and then the obtained solution is stirred for 30 seconds using a shaker to obtain a sample for particle size distribution measurement. Then, the particle size distribution is measured by the laser diffraction/scattering method using the sample for particle size distribution measurement. As a measuring device, a laser diffraction/scattering-type particle size distribution analyzer is used. Specific examples of the laser diffraction/scattering-type particle size distribution analyzer include Partica LA-960 manufactured by HORIBA, Ltd. The d50 described in the column of Examples described later is a value measured using Partica LA-960 manufactured by HORIBA, Ltd. as a laser diffraction/scattering-type particle size distribution analyzer.

In addition, the d50 of the magnetic particles contained in the magnetic particle-containing sheet can be confirmed, for example, by the following method. The magnetic particle-containing sheet is finely cut and then subjected to ultrasonic dispersion in a solvent (for example, acetone). From the obtained dispersion liquid, only a component that is adsorbed to a magnet, that is, only the magnetic particles are further separated as a sample, and measurement is performed using a laser diffraction/scattering method. In this manner, the d50 of the magnetic particles can be confirmed.

The d50 of the magnetic particles contained in the magnetic particle-containing sheet can be, for example, 1.0 μm or more. In addition, the d50 of the magnetic particles can be, for example, 50.0 μm or less. For example, magnetic particles having a d50 of 1.0 μm or more and 10.0 μm or less or 1.0 μm or more and 5.0 μm or less (hereinafter, also referred to as “small-size particles”) and magnetic particles having a d50 of more than 10.0 μm and 50.0 μm or less or 15.0 μm or more and 30.0 μm or less (hereinafter, also referred to as “large-size particles”) can be combined. Only one kind of small-size particles may be used as the small-size particles, or two or more kinds of small-size particles having different d50's may be used. Only one kind of large-size particles may be used as the large-size particles, or two or more kinds of large-size particles having different d50's may be used. Using smaller magnetic particles as the small-size particles can contribute to reducing the arithmetic mean of the median values of the major-axis diameters in (1) above and/or reducing the maximum value of the arithmetic means of the magnetic particle spacings in (3) above. Reducing the ratio of the large-size particles can contribute to reducing the arithmetic mean of the median values of the major-axis diameters in (1) above. Increasing the ratio of the large-size particles can contribute to increasing the arithmetic mean of the numbers of the magnetic particles in (2) above.

The content of the magnetic particles in the magnetic particle-containing sheet can be, for example, 60% by mass or more, 70% by mass or more, 80% by mass or more, 90% by mass or more, or 95% by mass or more, and can be, for example, less than 100% by mass, 99% by mass or less, or 98% by mass or less, with respect to the total mass of the sheet.

### <Resin>

The magnetic particle-containing sheet can contain at least the magnetic particles and can further contain a resin. In the present invention and the present specification, the “resin” means a polymer, and the polymer includes a homopolymer and a copolymer. As the resin, a resin having thermosetting properties or photocuring properties is preferable, and a thermosetting resin is more preferable. Examples of the thermosetting resins include various thermosetting resins such as an epoxy resin, a phenol resin, an acrylic resin, a silicone resin, a urethane resin, a urea resin, and a melamine resin, and from the viewpoint of durability of the sheet, an epoxy resin is preferable.

Examples of the epoxy resin include various epoxy resins, such as a bisphenol A epoxy resin, a bisphenol F epoxy resin, a bisphenol S epoxy resin, a bisphenol AF epoxy resin, a dicyclopentadiene epoxy resin, a trisphenol epoxy resin, a naphthol novolak epoxy resin, a phenol novolak epoxy resin, a tert-butyl-catechol epoxy resin, a naphthalene epoxy resin, a naphthol epoxy resin, an anthracene epoxy resin, a glycidylamine epoxy resin, a glycidyl ester epoxy resin, a cresol novolak epoxy resin, a biphenyl epoxy resin, a linear aliphatic epoxy resin, an epoxy resin having a butadiene structure, an alicyclic epoxy resin, a heterocyclic epoxy resin, an epoxy resin containing a spiro ring, a cyclohexanedimethanol epoxy resin, a naphthylene ether epoxy resin, and a trimethylol epoxy resin. The epoxy resin may be used alone, or two or more epoxy resins may be used in combination at an arbitrary proportion. A composition including an epoxy resin can be cured by opening a ring of an epoxy group included in the epoxy resin by heating to form a crosslinking structure. In the sheet formed by curing the composition containing an epoxy resin, a part or all of the epoxy groups contained in the epoxy resin can be contained in a state of being ring-opened to form a crosslinking structure.

The content of the resin in the magnetic particle-containing sheet is preferably in a range of 1.00 to 20.00 parts by mass with respect to 100.00 parts by mass of the magnetic particles. In addition, in a case where the magnetic particle-containing sheet contains two or more kinds of resins, the content of the resin is a total content of the two or more kinds of resins. The same applies to the contents and content ratios of other components. According to the studies of the present inventors, the smaller the amount of the resin, the smaller the arithmetic mean of the magnetic particle spacings in (3) tends to be.

### <Other Components>

The magnetic particle-containing sheet can be produced using a composition containing at least the magnetic particles and optionally containing a resin (hereinafter, also referred to as “composition for sheet formation”). The composition for sheet formation can contain a known additive in any amount. Examples of the additives include a component which can function as a curing catalyst for the thermosetting resin, a component which can function as a dispersant for the magnetic particles, a coupling agent, a surfactant, and a thixo agent. Such components are known, and examples thereof include a phenol compound, an amine compound, an imidazole compound, an acid anhydride, and a polymer-based dispersant.

The magnetic particle-containing sheet can also contain an additive (dispersant) which can contribute to the improvement of the dispersibility of the magnetic particles. An example of such a dispersant includes a compound containing a polyalkyleneimine chain and a polyester chain. In such a compound, a proportion of the polyalkyleneimine chain in the compound (hereinafter, also referred to as “polyalkyleneimine chain ratio”) is preferably less than 5.0% by mass, and a number average molecular weight of the polyalkyleneimine chain contained in the compound is also preferably in a range of 300 to 3,000. Here, the number average molecular weight of the polyalkyleneimine chain refers to the number average molecular weight described in paragraph 0027 of JP2015-28830A. For a method of measuring such a number average molecular weight, descriptions disclosed in paragraphs 0100 and 0101 of JP2015-28830A can also be referred to. The number average molecular weight of the polyalkyleneimine chain is more preferably 500 or more, and more preferably 2,000 or less. On the other hand, the proportion of the polyalkyleneimine chain in the compound (polyalkyleneimine chain ratio) is obtained according to the description disclosed in paragraph 0030 of JP2015-28830A. The polyalkyleneimine chain ratio is preferably 4.9% by mass or less, more preferably 4.8% by mass or less, still more preferably 4.5% by mass or less, even still more preferably 4.0% by mass or less, and even further still more preferably 3.0% by mass or less. In addition, the polyalkyleneimine chain ratio is preferably 0.2% by mass or more, more preferably 0.3% by mass or more, and still more preferably 0.5% by mass or more.

Examples of the polyalkyleneimine chain contained in the compound include a polymerized structure containing two or more alkyleneimine chains represented by Formula A described in paragraph 0032 of JP2015-28830A and/or Formula B described in paragraph 0034 of JP2015-28830A. In one aspect, the polyalkyleneimine chain can be a polyethyleneimine chain. On the other hand, examples of the polyester chain contained in the compound include a polyester chain represented by Formula 1 described in paragraph 0044 of JP2015-28830A and a polyester chain represented by Formula 2 described in paragraph 0046 of JP2015-28830A. For details of the above-described compound, descriptions disclosed in paragraphs 0026 to 0070 of JP2015-28830A and examples of JP2015-28830A can be referred to. The magnetic particle-containing sheet can contain 0.10 to 10.00 parts by mass of a dispersant with respect to 100.00 parts by mass of the magnetic particles. In one aspect, the magnetic particle-containing sheet can contain 0.10 to 10.00 parts by mass of a compound containing a polyalkyleneimine chain and a polyester chain (preferably a compound in which the polyalkyleneimine chain ratio is less than 5.0% by mass and more preferably a compound in which the number average molecular weight of the polyalkyleneimine chain is in a range of 300 to 3,000) with respect to 100.00 parts by mass of the magnetic particles.

The composition for sheet formation may be a composition not containing a solvent, and for example, one or more solvents can be contained in order to enhance coatability. Examples of the solvent include various organic solvents such as ketone solvents such as acetone, methyl ethyl ketone, and cyclohexanone, acetate solvents such as ethyl acetate, butyl acetate, cellosolve acetate, propylene glycol monomethyl ether acetate, and carbitol acetate, carbitols such as cellosolve and butylcarbitol, aromatic hydrocarbon solvents such as toluene and xylene, and amide solvents such as dimethylformamide, dimethylacetamide, and N-methylpyrrolidone. The solvent can be selected, for example, in consideration of the solubility of the components used in the preparation of the composition for sheet formation. As the solvent, one kind of solvent can be used, or two or more kinds of solvents can be mixed in an arbitrary proportion and used. In a case where the composition for sheet formation contains a solvent, the solvent can be used in any amount in consideration of the coatability of the composition.

The composition for sheet formation can be prepared by sequentially mixing various components in any order or by simultaneously mixing the various components. In addition, as necessary, a dispersion treatment can be carried out using a known dispersing machine such as a ball mill, a bead mill, a sand mill, or a roll mill, and/or a stirring treatment can be also carried out using a known stirrer such as a shaking type stirrer.

The ΔGAP described above can be controlled by the liquid viscosity of the composition for sheet formation. The higher the liquid viscosity is, the smaller the ΔGAP in the formed magnetic particle-containing sheet tends to be. The liquid viscosity can be adjusted by the liquid concentration (solid content mass/total mass) of the composition for sheet formation. The “solid content” means components excluding the solvent in a composition containing the solvent. A high magnetic particle concentration (magnetic particle mass/solid content mass) in the solid content of the composition for sheet formation can lead to an increase in the content of the magnetic particles in the formed magnetic particle-containing sheet. This can contribute to a decrease in the arithmetic mean of the magnetic particle spacings in the above (3).

The composition for sheet formation can be applied onto, for example, a support. The coating can be carried out using a known coating device such as a blade coater or a die coater. The coating can be carried out by a so-called roll-to-roll method or a batch method.

Examples of the support onto which the composition for sheet formation is applied include films of various resins, such as polyester such as polyethylene terephthalate (PET) and polyethylene naphthalate (PEN), polycarbonate (PC), acrylics such as polymethyl methacrylate (PMMA), cyclic polyolefin, triacetyl cellulose (TAC), polyether sulfide (PES), polyether ketone, and polyimide. For these resin films, reference can be made to paragraphs 0081 to 0086 of JP2015-187260A. As the support, a support on which a surface (coated surface) onto which the composition for sheet formation is applied has been subjected to a release treatment by a known method can be used. One form of the release treatment includes forming a release layer. For the release layer, reference can be made to paragraph 0084 of JP2015-187260A. In addition, as the support, a commercially available release-treated resin film can also be used. By using the support on which the surface to be coated has been subjected to the release treatment, the magnetic particle-containing sheet and the support can be easily separated from each other after film formation.

In a case where the composition for sheet formation is a curable composition, the magnetic particle-containing sheet can be formed as a cured layer in which the curable composition is cured by performing a curing treatment such as a heat treatment and light irradiation on the applied composition according to the type of the component contained in the composition. The curing treatment conditions may be determined according to the type of the component contained in the composition. In the present invention and the present specification, the “cured layer” includes a layer of a cured product in which progress of a curing reaction of a curable component contained in the curable composition is saturated or nearly saturated, and a layer of a partially cured product in which only a part of the curing reaction has progressed. For example, the magnetic particle-containing sheet can be a layer of a partially cured product before being used for manufacturing an inductor. In this case, for example, the curing can further progress in a case of heating and pressurization as described below.

The magnetic particle-containing sheet can be, for example, a single layer sheet. The thickness of the magnetic particle-containing sheet can be, for example, in a range of 5 μm to 2,000 μm. However, the thickness of the magnetic particle-containing sheet may be determined according to the use of the inductor or the like, and is not limited to the above-described range. The thickness of the sheet can be measured by a known contact or noncontact film thickness measuring means. As the thickness value, for example, an arithmetic mean of thicknesses measured at 20 selected at random locations can be adopted. Alternatively, the thickness of the sheet can be obtained as a designed thickness calculated from the manufacturing conditions.

Since the magnetic particle-containing sheet can exhibit a high magnetic permeability at various angles, the magnetic particle-containing sheet is suitable as a constituent member of an inductor.

### [Inductor]

One aspect of the present invention relates to an inductor including the magnetic particle-containing sheet.

The inductor can include one or more magnetic particle-containing sheets and a coil. The configuration of the inductor including the magnetic sheet (for example, the magnetic particle-containing sheet) and the coil is known, and a known technology can be applied to the inductor. For example, the inductor can be an inductor in which a laminate in which a coil is disposed between two magnetic sheets is heated and pressurized, and the sheets are pressure-bonded to seal the coil. In such an inductor, one or both of the two magnetic sheets can be the magnetic particle-containing sheet. In a case where both of the two magnetic sheets are the magnetic particle-containing sheet, the two magnetic sheets may have the same thickness and/or composition or may have different thicknesses and/or compositions. As the coil, a wound coil usually used for an inductor can be used.

### [Electronic Circuit]

One aspect of the present invention relates to an electronic circuit including the inductor.

Examples of one aspect of the electronic circuit including the inductor include a direct current (DC)/DC converter. For details of the DC/DC converter, descriptions disclosed in paragraphs 0009 to 0017 of JP2023-54823A and FIG. 1 of JP2023-54823A can be referred to. In addition, various electronic apparatuses can be manufactured using such an electronic circuit. Examples of the electronic apparatus including such an electronic circuit include a mobile information terminal such as a mobile phone, an automotive computer, a flat panel display, a game device, and a personal computer.

### EXAMPLES

Hereinafter, the present invention will be described in more detail with reference to Examples. However, the present invention is not limited to the embodiments shown in Examples.

Details of various components described below are as follows.
Large-size particles: nanocrystalline alloy magnetic particles KUAMET NC1 053C03A (manufactured by Epson Atmix Corporation, d50:23.9 μm)
Small-size particles 1: iron-based amorphous magnetic particles SAP-2D (manufactured by Shinto Industry Co., Ltd., d50:2.4 μm)
Small-size particles 2: iron-based amorphous magnetic material AW2-08 PF-3F (manufactured by Epson Atmix Corporation, d50:3.2 μm)
Epoxy resin 1: bisphenol A epoxy resin EXA-4816 (manufactured by DIC Corporation)
Epoxy resin 2: bisphenol A epoxy resin jER827 (manufactured by Mitsubishi Chemical Corporation)
Dispersant: polyalkyleneimine derivative J-2 of Synthesis Example 22 of JP2015-28830A (polyalkyleneimine chain ratio: 2.3% by mass, number average molecular weight of polyalkyleneimine chain: 600)
Curing catalyst: imidazole-type curing catalyst jER Cure IBMI12 (manufactured by Mitsubishi Chemical Corporation)
MEK: methyl ethyl ketone

### Example 1

<Production of Composition for Sheet formation (Magnetic Particle Dispersion Liquid)>

To a plastic bottle,
large-size particles: 68.40 parts by mass
small-size particles 1:31.60 parts by mass
dispersant: 0.24 parts by mass
epoxy resin 1:2.37 parts by mass
curing catalyst: 0.09 parts by mass
MEK (solvent): 3.49 parts by mass
were added, and the mixture was mixed with a shaking type stirrer for 30 minutes to prepare a magnetic particle dispersion liquid.

### <Measurement of Liquid Viscosity>

The liquid temperature of the prepared magnetic particle dispersion liquid was adjusted to 25 °C, and the liquid viscosity was measured using a viscometer (VM-10A-MH manufactured by Sekonic Corporation).

### <Production of Magnetic Particle-Containing Sheet>

The magnetic particle dispersion liquid was applied onto a release surface of a release-treated PET film (PET75TR manufactured by NIPPA Co., Ltd.) with a blade coater having a coating gap of 200 μm, and dried in a drying device having an internal atmospheric temperature of 80 °C for 1 hour to produce a magnetic particle-containing sheet.

### <Measurement of Magnetic Permeability at Various Measurement Angles>

The magnetic particle-containing sheet on the PET film was peeled off from the PET film, any orientation of the magnetic particle-containing sheet was set as a reference direction, and a measurement sample having a size of 28 mm×10 mm was cut out with the reference direction and the long side parallel to each other (0°). Similarly, the angle formed by the reference direction and the direction of the long side was set to angles of 15°, 30°, 45°, 60°, 75°, 90°, 105°, 120°, 135°, 150°, and 165°, and a measurement sample having a size of 28 mm×10 mm was cut out. Twelve rectangular measurement samples obtained by cutting out from different angular positions in this way were disposed in an oven having an internal atmospheric temperature of 150 °C for 2 hours to be cured.

The magnetic permeability at a frequency of 1 MHz was measured for each of the 12 cured measurement samples using a magnetic permeability measuring device PER01 (manufactured by KEYCOM Corporation). In a case where the complex relative magnetic permeability is measured by the magnetic permeability measuring device, a real part μ′ and an imaginary part μ″ are displayed. The magnetic permeability refers to the real part μ′.

The maximum value of magnetic permeability, the minimum value of magnetic permeability, and the arithmetic mean of magnetic permeability were obtained from the magnetic permeability of the 12 measurement samples. From the values obtained in this way, “Δ magnetic permeability=(maximum value of magnetic permeability−minimum value of magnetic permeability)/(maximum value of magnetic permeability+minimum value of magnetic permeability)” shown in Table 1 below was calculated.

The arithmetic mean of magnetic permeability can be an indicator that the magnetic permeability measured at various angles is high on average. The magnetic particle-containing sheet in which the arithmetic mean of magnetic permeability is 40.0 or more is preferable because the magnetic permeability measured at various angles is high on average. The magnetic particle-containing sheet in which the arithmetic mean of magnetic permeability is 45.0 or more is still more preferable.

A magnetic permeability can be an indicator of the anisotropy of magnetic permeability. The magnetic particle-containing sheet in which A magnetic permeability is 0.100 or less is preferable because the anisotropy of magnetic permeability is small.

### <SEM Observation and Measurement of Various Values>

A sample for SEM observation having a size of 5 mm×5 mm was cut out from any angular position of the magnetic particle-containing sheet peeled off from the PET film. The sample for SEM observation was disposed in an oven at an internal atmospheric temperature of 150 °C for 2 hours to be cured, and then subjected to SEM observation by the following method.

A carbon double-sided tape for SEM (7311, manufactured by Nissin EM Co., Ltd.) cut out to a length of 10 mm was attached to a metal sample stand for a tabletop microscope TM-1000 (manufactured by Hitachi High-Tech Corporation). The sample for SEM observation was attached to the carbon double-sided tape with the PET film side during coating facing the carbon double-sided tape side. The sample stand on which the sample for SEM observation was disposed was inserted into a tabletop microscope TM-1000 (manufactured by Hitachi High-Tech Corporation), and SEM observation was performed under the conditions of an observation magnification of 3000× and an observation range of 63 μm×47 μm, with the surface opposite to the PET film side during coating as a surface to be measured. The brightness and the contrast were adjusted by an auto brightness function, and the focus was adjusted by an auto focus function. The observation position was changed with an XY knob of a sample stage, and SEM observation was performed at five randomly selected locations to acquire images. Further, at any position selected at random, without changing the observation position, with 0 of the rotation button being defined as 0°, SEM observation was performed while changing the angle by clicking+of the rotation button, at angles of 0°, 15°, 30°, 45°, 60°, 75°, 90°, 105°, 120°, 135°, 150°, and 165° under the conditions of an observation magnification of 3000× and an observation range of 63 μm×47 μm, and a total of 12 images were acquired.

Various images thus obtained were subjected to binarization processing by the method described above to obtain binarized images. Using the obtained binarized images, the arithmetic mean of the median values of the major-axis diameters in (1) described above, the arithmetic mean of the numbers in (2) described above, the maximum value of the arithmetic means of the magnetic particle spacings in (3) described above, and ΔGAP were obtained by the method described above.

### Examples 2 to 6 and Comparative Examples 1 to 4

A magnetic particle-containing sheet was produced and various evaluations were performed as described in Example 1, except that the items shown in Table 1 were changed as shown in Table 1.

The above results are shown in Table 1.

TABLE 1

| | | | Example | Example | Example | Example | Example |
|---|---|---|---|---|---|---|---|
| | | | 1 | 2 | 3 | 4 | 5 |
| Magnetic | Large-size particles | [parts by | 68.40 | 68.40 | 68.40 | 63.20 | 70.00 |
| particles | (d50: 23.9 μm) | mass] | | | | | |
| | Small-size particles | [parts by | 31.60 | 31.60 | 31.60 | 18.40 | 30.00 |
| | 1 (d50: 2.4 μm) | mass] | | | | | |
| | Small-size particles | [parts by | | | | 18.40 | |
| | 2 (d50: 3.2 μm) | mass] | | | | | |
| Content of magnetic particles | | [parts by | 100.00 | 100.00 | 100.00 | 100.00 | 100.00 |
| | | mass] | | | | | |
| Dispersant | | [parts by | 0.24 | 0.24 | 0.24 | 0.24 | 0.24 |
| | | mass] | | | | | |
| Resin | Epoxy resin 1 | [parts by | 2.37 | | 2.37 | 2.37 | 2.37 |
| | | mass] | | | | | |
| | Epoxy resin 2 | [parts by | | 2.37 | | | |
| | | mass] | | | | | |
| Curing catalyst | | [parts by | 0.09 | 0.09 | 0.09 | 0.09 | 0.09 |
| | | mass] | | | | | |
| Solvent | MEK | [parts by | 3.49 | 3.49 | 4.12 | 3.49 | 3.49 |
| | | mass] | | | | | |
| Liquid concentration (solid content mass/total mass) | | [—] | 0.966 | 0.966 | 0.961 | 0.966 | 0.966 |
| Magnetic particle concentration in solid content | | [—] | 0.975 | 0.975 | 0.975 | 0.975 | 0.975 |
| (magnetic particle mass/solid content mass) | | | | | | | |
| Liquid viscosity | | [Pa · s] | 1.06 | 0.99 | 0.90 | 0.99 | 0.95 |
| Arithmetic mean of media values of major-axis | | [μm] | 0.95 | 0.94 | 0.98 | 1.02 | 1.07 |
| diameters in (1) | | | | | | | |
| Arithmetic mean of numbers in (2) | | [number] | 9 | 10 | 10 | 12 | 12 |
| Maximum value of arithmetic means of magnetic | | [μm] | 0.94 | 0.99 | 0.97 | 1.14 | 1.02 |
| particle spacing in (3) | | | | | | | |
| ΔGAP | | [—] | 0.11 | 0.10 | 0.18 | 0.12 | 0.15 |
| Maximum value of magnetic permeability | | [—] | 51.5 | 50.1 | 50.9 | 48.7 | 50.3 |
| Minimum value of magnetic permeability | | [—] | 43.6 | 41.1 | 40.9 | 40.4 | 39.6 |
| Arithmetic mean of magnetic permeability | | [—] | 46.8 | 45.3 | 46.0 | 44.3 | 44.9 |
| Δ magnetic permeability = (maximum value of | | [—] | 0.083 | 0.099 | 0.109 | 0.093 | 0.119 |
| magnetic permeability − minimum value of magnetic | | | | | | | |
| permeability)/(minimum value of magnetic | | | | | | | |
| permeability + minimum value of magnetic | | | | | | | |
| permeability) | | | | | | | |
| | | | | Compar- | Compar- | Compar- | Compar- |
| | | | | ative | ative | ative | ative |
| | | | Example | Exam- | Exam- | Exam- | Exam- |
| | | | 6 | ple 1 | ple 2 | ple 3 | ple 4 |
| Magnetic | Large-size particles | [parts by | 71.10 | 75.00 | 68.40 | 68.40 | 64.60 |
| particles | (d50: 23.9 μm) | mass] | | | | | |
| | Small-size particles | [parts by | 28.90 | | 15.80 | 31.60 | 35.40 |
| | 1 (d50: 2.4 μm) | mass] | | | | | |
| | Small-size particles | [parts by | | 25.00 | 15.80 | | |
| | 2 (d50: 3.2 μm) | mass] | | | | | |
| Content of magnetic particles | | [parts by | 100.00 | 100.00 | 100.00 | 100.00 | 100.00 |
| | | mass] | | | | | |
| Dispersant | | [parts by | 0.24 | 0.28 | 0.24 | 0.24 | 0.24 |
| | | mass] | | | | | |
| Resin | Epoxy resin 1 | [parts by | 2.37 | 2.34 | 2.37 | 2.71 | 2.37 |
| | | mass] | | | | | |
| | Epoxy resin 2 | [parts by | | | | | |
| | | mass] | | | | | |
| Curing catalyst | | [parts by | 0.09 | 0.11 | 0.09 | 0.09 | 0.09 |
| | | mass] | | | | | |
| Solvent | MEK | [parts by | 3.49 | 3.98 | 3.23 | 3.49 | 3.49 |
| | | mass] | | | | | |

| | | | | | | |
|---|---|---|---|---|---|---|
| Liquid concentration (solid content mass/total mass) | [—] | 0.966 | 0.962 | 0.969 | 0.966 | 0.966 |
| Magnetic particle concentration in solid content | [—] | 0.975 | 0.974 | 0.975 | 0.971 | 0.975 |
| (magnetic particle mass/solid content mass) | | | | | | |
| Liquid viscosity | [Pa · s] | 0.91 | 0.80 | 1.05 | 0.92 | 1.10 |
| Arithmetic mean of media values of major-axis | [μm] | 1.12 | 2.04 | 1.24 | 1.02 | 0.89 |
| diameters in (1) | | | | | | |
| Arithmetic mean of numbers in (2) | [number] | 14 | 14 | 7 | 10 | 5 |
| Maximum value of arithmetic means of magnetic | [μm] | 1.12 | 1.36 | 1.20 | 1.29 | 0.94 |
| particle spacing in (3) | | | | | | |
| ΔGAP | [—] | 0.22 | 0.17 | 0.12 | 0.14 | 0.10 |
| Maximum value of magnetic permeability | [—] | 49.7 | 45.6 | 41.5 | 39.9 | 42.8 |
| Minimum value of magnetic permeability | [—] | 39.6 | 31.2 | 34.7 | 32.3 | 36.4 |
| Arithmetic mean of magnetic permeability | [—] | 43.9 | 38.7 | 38.4 | 36.5 | 39.7 |
| Δ magnetic permeability = (maximum value of | [—] | 0.113 | 0.188 | 0.089 | 0.105 | 0.081 |
| magnetic permeability − minimum value of magnetic | | | | | | |
| permeability)/(minimum value of magnetic | | | | | | |
| permeability + minimum value of magnetic | | | | | | |
| permeability) | | | | | | |

One aspect of the present invention is useful in the technical field of various electronic circuits.

What is claimed is:

1. A magnetic particle-containing sheet satisfying the following (1), (2), and (3):
(1) an arithmetic mean of median values of major-axis diameters of magnetic particles obtained from respective five images acquired by observing any five measurement regions on a surface of the magnetic particle-containing sheet with a scanning electron microscope is 1.20 μm or less, each of the five measurement regions has a size of 63 μm×47 μm, and an observation magnification of the scanning electron microscope is 3000×;
(2) an arithmetic mean of the numbers of magnetic particles having major-axis diameters of 5.00 μm or more, the major-axis diameters being obtained from the respective five images, is 6 or more; and
(3) with an arbitrary measurement angle being defined as 0°, a maximum value of arithmetic means of magnetic particle spacings, the arithmetic means being obtained from respective 12 images acquired by observing any one measurement region on the surface of the magnetic particle-containing sheet with the scanning electron microscope at respective measurement angles of 0°, 15°, 30°, 45°, 60°, 75°, 90°, 105°, 120°, 135°, 150°, and 165°, is 1.20 μm or less, the one measurement region has a size of 63 μm×47 μm, and an observation magnification of the scanning electron microscope is 3000×.

2. The magnetic particle-containing sheet according to claim 1, wherein the maximum value of the arithmetic means of the magnetic particle spacings in (3) is 1.00 μm or less.

3. The magnetic particle-containing sheet according to claim 1, wherein, with the maximum value of the arithmetic means of the magnetic particle spacings in (3) being defined as GAPH and a minimum value of the arithmetic means of the magnetic particle spacings in (3) being defined as GAPL, ΔGAP obtained by the following expression:
ΔGAP=(GAPH−GAPL)/(GAPH+GAPL)
is 0.13 or less.

4. The magnetic particle-containing sheet according to claim 3, wherein the ΔGAP is 0.05 or more and 0.13 or less.

5. The magnetic particle-containing sheet according to claim 1, wherein the arithmetic mean of the median values of the major-axis diameters in (1) is 0.80 μm or more and 1.20 μm or less.

6. The magnetic particle-containing sheet according to claim 1, wherein the arithmetic mean of the numbers in (2) is 6 or more and 20 or less.

7. The magnetic particle-containing sheet according to claim 1, wherein the maximum value of the arithmetic means of the magnetic particle spacings in (3) is 0.80 μm or more and 1.20 μm or less.

8. The magnetic particle-containing sheet according to claim 1, wherein the magnetic particle-containing sheet further contains a resin.

9. The magnetic particle-containing sheet according to claim 1, wherein the maximum value of the arithmetic means of the magnetic particle spacings in (3) is 1.00 μm or less, and
with the maximum value of the arithmetic means of the magnetic particle spacings in (3) being defined as GAPH and a minimum value of the arithmetic means of the magnetic particle spacings in (3) being defined as GAPL, ΔGAP obtained by the following expression:
ΔGAP=(GAPH−GAPL)/(GAPH+GAPL)
is 0.13 or less.

10. The magnetic particle-containing sheet according to claim 9, wherein the ΔGAP is 0.05 or more and 0.13 or less,
the arithmetic mean of the median values of the major-axis diameters in (1) is 0.80 μm or more and 1.20 μm or less,
the arithmetic mean of the numbers in (2) is 6 or more and 20 or less,
the maximum value of the arithmetic means of the magnetic particle spacings in (3) is 0.80 μm or more and 1.00 μm or less, and
the magnetic particle-containing sheet further contains a resin.

11. An inductor comprising the magnetic particle-containing sheet according claim 1.

12. An electronic circuit comprising the inductor according to claim 11.
